(19) United States
(12) Patent Application Publication
(10) Pub. No.: US 2004/0264127 A1
(43) Pub. Date: Dec. 30, 2004

(54) CEILING VENTILATION ARRANGEMENT FOR PERSONAL COMPUTER CASE

(76) Inventor: Rick Chiu, City of Industry, CA (US)

Correspondence Address: Raymond Y. Chan, Suite 128, 108 N. Ynez Ave., Monterey Park, CA, 91754, US

(21) Appl. No.: 10/606,415

(22) Filed: Jun. 27, 2003

(51) Int. Cl. G06F 1/20

(52) U.S. Cl. 361/687

(57) ABSTRACT

A computer case includes a case body defining a storage compartment and a ceiling window on a top platform, and a ceiling ventilation arrangement including a supporting frame and a ventilation fan unit. The supporting frame includes a base, having a fan cavity, mounted on the top platform to communicate the fan cavity with the storage compartment, and a protective cover pivotally connected with the base. The ventilation fan unit is coupled with the protective cover, wherein the ventilation fan unit is driven by the protective cover to move between a storage position that the protective cover is folded to enclose the fan cavity and to protect the ventilation fan unit therewithin and an operated position that the protective cover is folded to drive the ventilation fan unit to inclinedly supported within the fan cavity for providing a sucking force to suck hot air within the storage compartment.

### BACKGROUND OF THE PRESENT INVENTION

1. Field of Invention

The present invention relates to a cooling device for a personal computer, and more particularly to a ceiling ventilation arrangement for the personal computer, which can effectively dissipate the heat generated from the components of the personal computer within the case thereof so as to prevent the personal computer from being overheated.

2. Description of Related Arts

Due to the dramatically need of a personal computer, the components of the personal computer must be upgraded, such as increasing the storage capacity of a hard drive, the CUP speed, and the power supply, to enhance the performance of the personal computer. It is essential to dissipate the heat generated by the components of the personal computer during operation for ensuring the components remain within their normal operation temperature ranges so as to prolong the service life spans thereof.

Accordingly, the personal computer incorporates with a fan-based cooling system which comprises a CUP fan mounted at a position closed to the CUP for dissipating the heat therefrom and a power supply fan positioned at a rear wall of the computer case for dissipating the heat from the power supply. However, such cooling system has several drawbacks.

Since the CUP fan and the power supply fan are designed for particular works. Once one of the fans is fail to operate, another fan cannot provide enough sucking power to suck the hot air within the computer case to outside. In other words, there is no back-up cooling fan for dissipating the heat within the computer case to outside so as to prevent the personal computer from being overheated.

In addition, it is an inconvenience for the user to check whether both the CUP fan and the power supply fan are functioning or not unless the user opens up the computer case. Therefore, if the non-operated fan is not replaced immediately, the personal computer will be overheated when one of the fans is accidentally fail to operate. It is essential to clean the fans frequently in order to keep the fans functioning properly. Once the dust and dirt are stuck at the fans, the fans are either fail or locked up. However, most users ignore to clean the fans since it is a hassle for them to open up the computer case to inspect the operating condition of the fans.

An improved cooling system may employ an additional cooling fan mounted on a sidewall of the computer case to suck the hot air to outside. However, due to the physical properties of heat flow, the hot air flows upwardly in such a manner that the heat will trap at a top portion of the computer case instead of being sucked via the additional cooling fan sidewardly. In other words, the additional cooling fan is not effectively to dissipate the heat within the computer case.

### SUMMARY OF THE PRESENT INVENTION

A main object of the present invention is to provide a ceiling ventilation arrangement for a personal computer case, which can effectively dissipate the heat generated from the components of the personal computer within the case thereof so as to prevent the personal computer from being overheated.

Another object of the present invention is to provide a ceiling ventilation arrangement for a personal computer case, wherein a ventilating fan of the ceiling ventilation arrangement is mounted on top of the computer case so as to effectively suck out the hot air within the computer case with respect to the physical properties of heat flow.

Another object of the present invention is to provide a ceiling ventilation arrangement for a personal computer case, wherein the ventilating fan is inclinedly supported on the computer case so as to create an efficiently sucking force to suck the hot air out of the computer case.

Another object of the present invention is to provide a ceiling ventilation arrangement for a personal computer case, wherein the ventilating fan is electrically connected to the power supply of the personal computer such that the ventilating fan is automatically switched on when the personal computer is on. In other words, the ventilating fan operates only when the personal computer is operating.

Another object of the present invention is to provide a ceiling ventilation arrangement for a personal computer case, which comprises a protective cover not only normally covering on the ventilating fan to prevent the dust entering into the ventilation fan and the computer case, but also functioning as a fan guider for detouring the discharged hot air from the computer case to outside via the ventilating fan.

Another object of the present invention is to provide a ceiling ventilation arrangement for a personal computer case, wherein the installation of the ceiling ventilation arrangement is easy and simple that by mounting the ceiling ventilation arrangement on top of the computer case and electrically connecting the ceiling ventilation arrangement to the power supply of the personal computer.

Accordingly, in order to accomplish the above objects, the present invention provides a computer case, comprising:

a case body defining a storage compartment and having a top platform wherein the top platform has a ceiling window for communicating the storage compartment with outside; and

a ceiling ventilation arrangement, comprising:

a supporting frame comprising a base, having a fan cavity, mounted on the top platform at a position that the fan cavity is communicated with the storage compartment through the ceiling window, and a protective cover pivotally connected with the base to enclose the fan cavity; and

a ventilation fan unit, which is adapted for electrically connecting to a power source, coupled with the protective cover, wherein the ventilation fan unit is driven by the protective cover to move between an operated position and a storage position, wherein at the operated position, the protective cover pivotally folds upward to drive the ventilation fan unit to inclinedly supported within the fan cavity for providing a sucking force to suck hot air within the storage compartment, and at the storage position, the protective cover pivotally folds downward to enclose the fan cavity so as to protect the ventilation fan unit within the fan cavity.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a ceiling ventilation arrangement for a personal computer case according to a preferred embodiment of the present invention.

FIG. 2 is an exploded perspective view of the ceiling ventilation arrangement for the personal computer case according to the above preferred embodiment of the present invention.

FIG. 3 is a sectional view of the ceiling ventilation arrangement at a storage position according to the above preferred embodiment of the present invention.

FIG. 4 is a sectional view of the ceiling ventilation arrangement at an operated position according to the above preferred embodiment of the present invention.

FIG. 5 is a top view of the ceiling ventilation arrangement for the personal computer case according to the above preferred embodiment of the present invention.

FIG. 6 is a perspective view of the ceiling ventilation arrangement for the personal computer case according to the above preferred embodiment of the present invention, illustrating the handle frame folding up from the computer case.

### DETAILED DESCRIPTION OF THE PREFERRED EMBODIMENT

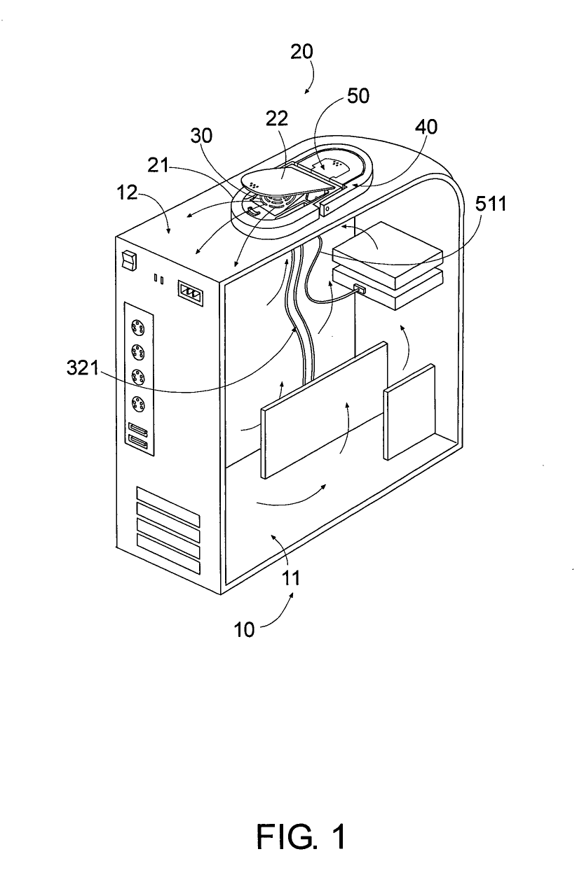

Referring to FIGS. 1, 2 and 3 of the drawings, a computer case according to a preferred embodiment of the present invention is illustrated, wherein the computer case comprises a case body 10 and a ceiling ventilation arrangement 2.

The case body 10 defines a storage compartment 11 and has a top platform 12 wherein the top platform 12 has a ceiling window 121 for communicating the storage compartment 11 with outside.

The ceiling ventilation arrangement 2 comprises a supporting frame 20 supported on the top platform 12 of the case body 10 and a ventilation fan unit 30 adapted for electrically connecting to a power source.

The supporting frame 20 comprising a base 21, having a fan cavity 210, mounted on the top platform 12 at a position that the fan cavity 210 is communicated with the storage compartment 11 through the ceiling window 121, and a protective cover 22 pivotally connected with the base 21 to enclose the fan cavity 210.

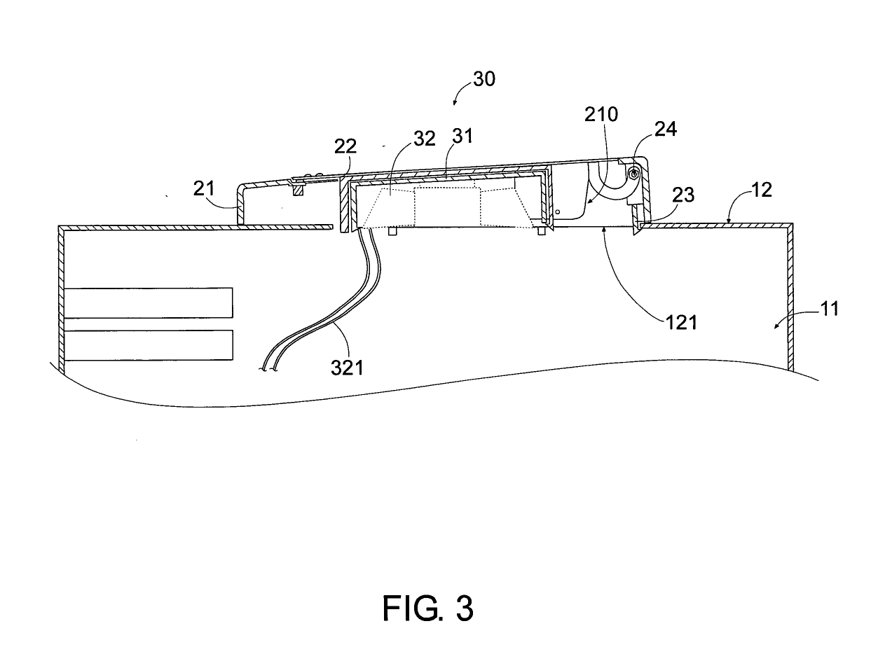

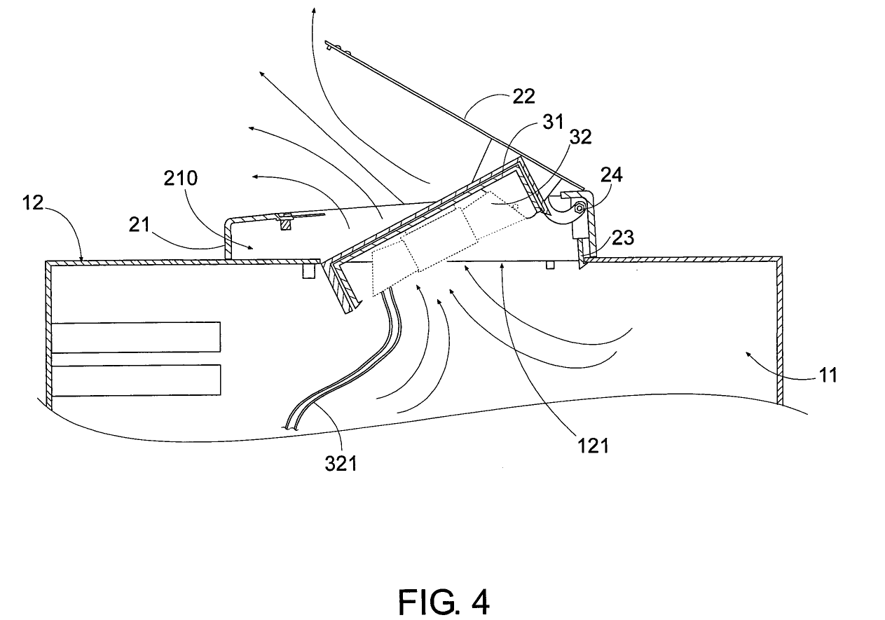

The ventilation fan unit 30 is coupled with the protective cover 22, wherein the ventilation fan unit 30 is driven by the protective cover 22 to move between an operated position and a storage position, wherein at the operated position as shown in FIG. 4, the protective cover 22 pivotally folds upward to drive the ventilation fan unit 30 to inclinedly supported within the fan cavity 210 for providing a sucking force to suck hot air within the storage compartment 11, and at the storage position as shown in FIG. 3, the protective cover 22 pivotally folds downward to enclose the fan cavity 210 so as to protect the ventilation fan unit 30 within the fan cavity 210.

According to the preferred embodiment, the base 21 of the supporting frame 20 is mounted on the top platform 12 of the case body 10 to align the fan cavity 210 with the ceiling window 121 in such a manner that the storage compartment 11 is communicated with outside through the fan cavity 210.

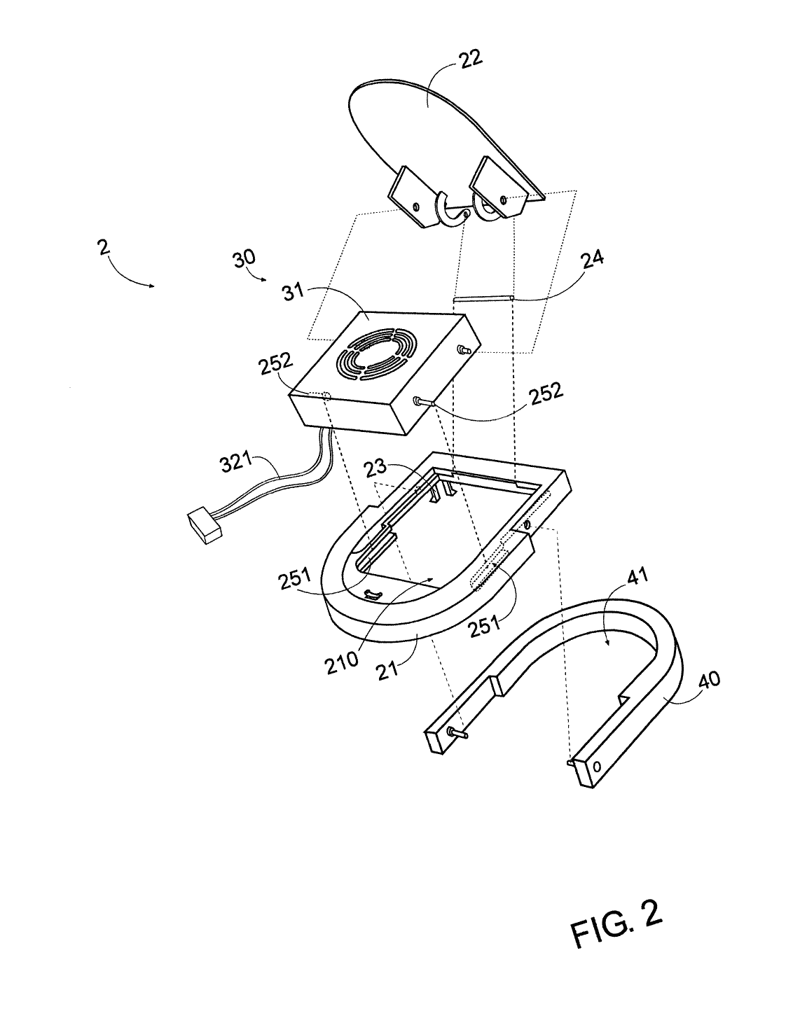

As shown in FIGS. 2 and 3, the supporting frame 20 further comprises a plurality of engaging arms 23 downwardly extended from the base 21 towards the storage compartment 11 to substantially mount on the top platform 12 so as to mount the base 21 thereon. Each of the engaging arms 23 has a hooking end 231 extended downwardly to a position within the storage compartment 11 to engage with a peripheral edge of the ceiling window 121 so as to substantially hold the base 21 on the top platform 12 in position, as shown in FIG. 3. Accordingly, the ceiling ventilation arrangement 2 can be detachably attached to the case body 10 of a conventional personal computer having the ceiling window 121 on the top platform 12.

The base 21, according to the preferred embodiment, is embodied as a boundary frame defining the fan cavity 210 therein wherein the fan cavity 210 is shaped and sized to fit the ventilation fan unit 30 to disposed therein.

It is worth to mention that the base 21 can be integrally extended from the top platform 12 to form a one-piece integral member such that the ceiling ventilation arrangement 2 can be built-in with the case body 10 to provide the ventilation effect of the personal computer.

The protective cover 22 is pivotally connected with the base 21 via a pivot joint 24 wherein the protective cover 22 is upwardly and pivotally folded with respect to the base 21 to its opened position for allowing the fan cavity 210 to communicate with outside so that the hot air within the storage compartment 11 of the case body 10 is capable of flowing to outside through the fan cavity 210. In addition, the protective cover 22 is capable of downwardly and pivotally folded with respect to the base 21 to its closed position to enclose the fan cavity 210 so as to prevent any dirt and dust from entering into the fan cavity 210 and the storage compartment 11 of the case body 10.

The ventilation fan unit 30 comprises a fan housing 31 pivotally connected to the protective cover 22 and a ventilating fan 32 received in the fan housing 31 in such a manner that when the protective cover 22 is folded upwardly, the fan housing 31 is driven to move upwardly from the fan cavity 210 to a position that the ventilating fan 32 is inclinedly supported within the fan cavity 210. As shown in FIG. 2, the protective cover 22 is pivotally connected to an upper portion of the fan housing 31 such that when the protective cover 22 is folded upwardly, the upper portion of the fan housing 31 is lifted upwardly from the fan cavity 210 to inclinedly support the ventilating fan 32.

The ventilating fan 32 is capable of electrically connecting to a power supply of the personal computer as the power source via an electric cable 321 wherein the electric cable 321 is extended from the ventilating fan 32 into the storage compartment 11 through the ceiling window 121 to electrically connect with the power supply. In other words, the ventilating fan 32 is automatically switched on when the power of the personal computer is on. Therefore, the ventilating fan 32 operates only when the personal computer is operating. In other words, the user is able to simply inspect the operation of the ventilating fan 32 by observation without opening the computer case.

It is worth to mention that when the ventilating fan 32 is inclinedly supported at the fan cavity 210 to provide the sucking effect, an airflow is created within the storage compartment 11 of the case body 10 in accordance with the physical properties of heat flow, so as to effectively suck out the hot air from the storage compartment 11 to outside, as shown in FIG. 1.

The supporting frame 20 further comprises a guiding unit 25 for guiding the ventilation fan unit 30 to move between the storage position and the operated position. As shown in FIG. 2, the guiding unit 25 has two sliding tracks 251 provided along two sidewalls of the fan cavity 210 respectively and comprises two slider pegs 252 sidewardly extended from two sidewalls of the fan housing 31 at a lower portion thereof respectively, wherein the fan housing 31 is disposed within the fan cavity 210 while the two slider pegs 252 are slidably inserted into the two sliding tracks 251 respectively in such a manner that when the upper portion of the fan housing 31 is lifted upwardly by the protective cover 22, the slider pegs 252 are slid along the sliding tracks 251 respectively to retain the lower portion of the fan housing 31 within the fan cavity 210 so as to inclinedly support the ventilating fan 32 in position, as shown in FIG. 4.

Each of the sliding tracks 252, having a predetermined length, is indented on the respective sidewall of the fan cavity 210 wherein each of the sliding tracks 252 has a stopper end 252A arranged in such a manner that when the protective cover 22 is upwardly folded to lift up the fan housing 31, the slider pegs 252 are stopped at the stopper ends 252A of the sliding tracks 252 respectively to block the sliding movement of the fan housing 31 so as to inclinedly support the ventilating fan 32 in position.

Therefore, when the protective cover 22 folds downwardly to enclose the fan cavity 201, the slider pegs 252 are driven to slide along the sliding tracks 251 respectively to downwardly push the upper portion of the fan housing 31 back into the fan cavity 210, as shown in FIG. 3.

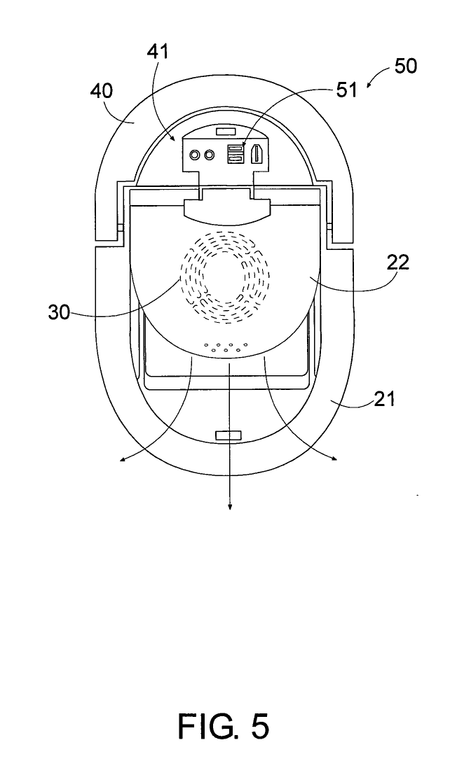

As shown in FIGS. 1 and 5, when the ventilation fan 30 is moved to the operated position, the protective cover 22 is inclinedly supported to function as an air guider for guiding a flow of the hot air to discharge from the storage compartment 11, so as to enhance the sucking effect of the ventilation fan unit 30. In addition, the protective cover 22 functions as a dust shelter to prevent any dirt or dust entering into the storage compartment 11 while the ventilating fan 32 is operating.

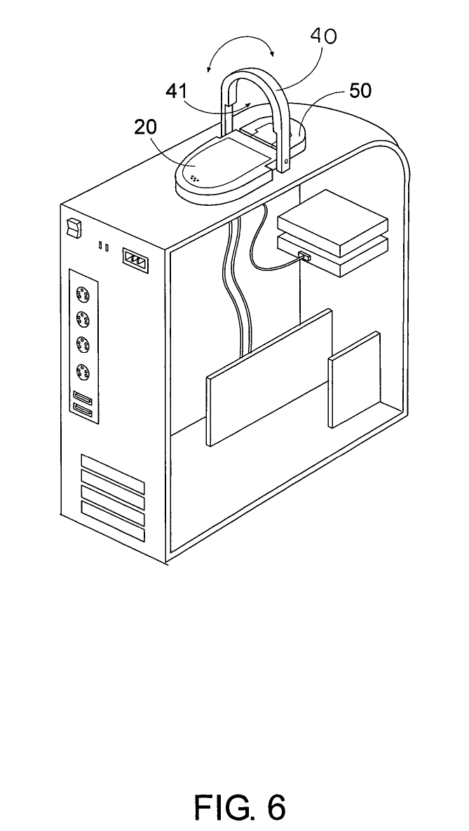

The ceiling ventilation arrangement 2 further comprises a handle frame 40 pivotally connected to the base 21 of the supporting frame 20 wherein the handle frame 40, having a U-shaped, has two ends rotatably connected to two outer sides of the base 21 respectively in such a manner that the handle frame 40 is capable of folding upwardly to form as a hand bar and folding downwardly to rest on the top platform 12, as shown in FIG. 6.

The ceiling ventilation arrangement 2 further comprises a supplementary connection link 50 mounted on the top platform 12 at a position in front of the supporting frame 20 wherein the supplementary connection link 50 comprises at least a computer outlet 51 adapted for communicatively connecting with the connection output of the personal computer via a connection cable 511 while the connection cable 511 is extended from the computer outlet 51 for connecting with the connection output of the personal computer through the ceiling window 121 of the case body 10.

Accordingly, the computer outlet 51 can be a USB connector, an IEEE 1394 connector, or sound card ports provided on top of the case body 10 so as to provide a supplementary connection outlet for maximum accessibility. It is worth to mention that when the personal computer is placed on the floor under the desk, the supplementary connection link 50 is useful since the computer outlet 51 is located on top of the computer case so that the user is able to easily plug any computer accessory to the personal computer through the supplementary connection link 50.

As shown in FIG. 1, the handle frame 40 forms a boundary cavity 41 when the handle frame 40 is downwardly folded to rest on the top platform 12 wherein the supplementary connection link 50 is mounted on the top platform 12 at a position within the boundary cavity 41 such that the supplementary connection link 50 is encircled within the handle frame 40. In other words, the ceiling ventilation arrangement 2 of the present invention has specifically design to form a compact unit which occupies less space on the computer case.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure form such principles. Therefore, this invention includes all modifications encompassed within the spirit and scope of the following claims.

What is claimed is:

1. A computer case for a personal computer, comprising:
a case body defining a storage compartment and having a top platform wherein said top platform has a ceiling window for communicating said storage compartment with outside; and
a ceiling ventilation arrangement, comprising:
a supporting frame comprising a base, having a fan cavity, mounted on said top platform at a position that said fan cavity is communicated with said storage compartment through said ceiling window, and a protective cover pivotally connected with said base to enclose said fan cavity; and
a ventilation fan unit, which is adapted for electrically connecting to a power source, coupled with said protective cover, wherein said ventilation fan unit is driven by said protective cover to move between an operated position and a storage position, wherein at said operated position, said protective cover pivotally folds upward to drive said ventilation fan unit to inclinedly supported within said fan cavity for providing a sucking force to suck hot air within said storage compartment, and at said storage position, said protective cover pivotally folds downward to enclose said fan cavity so as to protect said ventilation fan unit within said fan cavity.

2. The computer case, as recited in claim 1, wherein said ventilation fan unit comprises a fan housing having an upper portion pivotally connected to said protective cover and a ventilating fan received in said fan housing for electrically connecting with said power source, in such a manner that when said protective cover is folded upwardly, said upper portion of said fan housing is lifted upwardly from said fan cavity to inclinedly support said ventilating fan in position.

3. The computer case, as recited in claim 2, wherein said supporting frame further comprises a guiding unit for guiding said ventilation fan unit to move between said storage position and said operated position, wherein said guiding unit has two sliding tracks provided along two sidewalls of said fan cavity respectively and comprises two slider pegs sidewardly extended from two sidewalls of said fan housing at a lower portion thereof respectively, wherein said fan housing is disposed within said fan cavity while said two slider pegs are slidably inserted into said two sliding tracks respectively in such a manner that when said upper portion of said fan housing is lifted upwardly by said protective cover, said slider pegs are slid along said sliding tracks respectively to retain said lower portion of said fan housing within said fan cavity so as to inclinedly support said ventilating fan in position.

4. The computer case, as recited in claim 3, wherein each of said sliding tracks, having a predetermined length, is indented on said respective sidewall of said fan cavity, wherein each of said sliding tracks has a stopper end arranged in such a manner that when said protective cover is upwardly folded to lift up said fan housing, said slider pegs are stopped at said stopper ends of said sliding tracks respectively to block a sliding movement of said fan housing so as to inclinedly support said ventilating fan in position.

5. The computer case, as recited in claim 1, wherein said supporting frame further comprises a plurality of engaging arms downwardly extended from said base towards said storage compartment to substantially mount on said top platform, wherein each of said engaging arms has a hooking end extended downwardly to a position within said storage compartment to engage with a peripheral edge of said ceiling window so as to substantially hold said base on said top platform in position.

6. The computer case, as recited in claim 2, wherein said supporting frame further comprises a plurality of engaging arms downwardly extended from said base towards said storage compartment to substantially mount on said top platform, wherein each of said engaging arms has a hooking end extended downwardly to a position within said storage compartment to engage with a peripheral edge of said ceiling window so as to substantially hold said base on said top platform in position.

7. The computer case, as recited in claim 4, wherein said supporting frame further comprises a plurality of engaging arms downwardly extended from said base towards said storage compartment to substantially mount on said top platform, wherein each of said engaging arms has a hooking end extended downwardly to a position within said storage compartment to engage with a peripheral edge of said ceiling window so as to substantially hold said base on said top platform in position.

8. The computer case, as recited in claim 1, wherein said ceiling ventilation arrangement further comprises a handle frame pivotally connected to said supporting frame, wherein said handle frame, having a U-shaped, has two ends rotatably connected to two outer sides of said base respectively in such a manner that said handle frame is capable of folding upwardly to form as a hand bar and folding downwardly to rest on said top platform.

9. The computer case, as recited in claim 4, wherein said ceiling ventilation arrangement further comprises a handle frame pivotally connected to said supporting frame, wherein said handle frame, having a U-shaped, has two ends rotatably connected to two outer sides of said base respectively in such a manner that said handle frame is capable of folding upwardly to form as a hand bar and folding downwardly to rest on said top platform.

10. The computer case, as recited in claim 7, wherein said ceiling ventilation arrangement further comprises a handle frame pivotally connected to said supporting frame, wherein said handle frame, having a U-shaped, has two ends rotatably connected to two outer sides of said base respectively in such a manner that said handle frame is capable of folding upwardly to form as a hand bar and folding downwardly to rest on said top platform.

11. The computer case, as recited in claim 1, wherein said ceiling ventilation arrangement further comprises a supplementary connection link mounted on said top platform at a position in front of said supporting frame, wherein said supplementary connection link comprises at least a computer outlet adapted for communicatively connecting with a connection output of said personal computer.

12. The computer case, as recited in claim 7, wherein said ceiling ventilation arrangement further comprises a supplementary connection link mounted on said top platform at a position in front of said supporting frame, wherein said supplementary connection link comprises at least a computer outlet adapted for communicatively connecting with a connection output of said personal computer.

13. The computer case, as recited in claim 10, wherein said ceiling ventilation arrangement further comprises a supplementary connection link mounted on said top platform at a position in front of said supporting frame, wherein said supplementary connection link comprises at least a computer outlet adapted for communicatively connecting with a connection output of said personal computer.

14. The computer case, as recited in claim 13, wherein said handle frame forms a boundary cavity when said handle frame is downwardly folded to rest on said top platform, wherein said supplementary connection link is mounted on said top platform at a position within said boundary cavity such that said supplementary connection link is encircled within said handle frame.

15. A ceiling ventilation arrangement for a computer case of a personal computer which comprises a case body defining a storage compartment and a ceiling window forming on a top platform for communicating said storage compartment with outside, wherein said ceiling ventilation arrangement comprises:
a supporting frame comprising a base, having a fan cavity, adapted for mounting on said top platform at a position that said fan cavity is communicated with said storage compartment through said ceiling window, and a protective cover pivotally connected with said base to enclose said fan cavity; and
a ventilation fan unit, which is adapted for electrically connecting to a power source, coupled with said protective cover, wherein said ventilation fan unit is driven by said protective cover to move between an operated position and a storage position, wherein at said operated position, said protective cover pivotally folds upward to drive said ventilation fan unit to inclinedly supported within said fan cavity for providing a sucking force to suck hot air within said storage compartment, and at said storage position, said protective cover pivotally folds downward to enclose said fan cavity so as to protect said ventilation fan unit within said fan cavity.

16. The ceiling ventilation arrangement, as recited in claim 15, wherein said ventilation fan unit comprises a fan housing having an upper portion pivotally connected to said protective cover and a ventilating fan received in said fan housing for electrically connecting with said power source, in such a manner that when said protective cover is folded upwardly, said upper portion of said fan housing is lifted upwardly from said fan cavity to inclinedly support said ventilating fan in position.

17. The ceiling ventilation arrangement, as recited in claim 16, wherein said supporting frame further comprises a guiding unit for guiding said ventilation fan unit to move between said storage position and said operated position, wherein said guiding unit has two sliding tracks provided along two sidewalls of said fan cavity respectively and comprises two slider pegs sidewardly extended from two sidewalls of said fan housing at a lower portion thereof respectively, wherein said fan housing is disposed within said fan cavity while said two slider pegs are slidably inserted into said two sliding tracks respectively in such a manner that when said upper portion of said fan housing is lifted upwardly by said protective cover, said slider pegs are slid along said sliding tracks respectively to retain said lower portion of said fan housing within said fan cavity so as to inclinedly support said ventilating fan in position.

18. The ceiling ventilation arrangement, as recited in claim 17, wherein each of said sliding tracks, having a predetermined length, is indented on said respective sidewall of said fan cavity, wherein each of said sliding tracks has a stopper end arranged in such a manner that when said protective cover is upwardly folded to lift up said fan housing, said slider pegs are stopped at said stopper ends of said sliding tracks respectively to block a sliding movement of said fan housing so as to inclinedly support said ventilating fan in position.

19. The ceiling ventilation arrangement, as recited in claim 15, wherein said supporting frame further comprises a plurality of engaging arms downwardly extended from said base towards said storage compartment for substantially mounting on said top platform, wherein each of said engaging arms has a hooking end extended downwardly to a position within said storage compartment for engaging with a peripheral edge of said ceiling window so as to substantially hold said base on said top platform in position.

20. The ceiling ventilation arrangement, as recited in claim 18, wherein said supporting frame further comprises a plurality of engaging arms downwardly extended from said base towards said storage compartment for substantially mounting on said top platform, wherein each of said engaging arms has a hooking end extended downwardly to a position within said storage compartment for engaging with a peripheral edge of said ceiling window so as to substantially hold said base on said top platform in position.

21. The ceiling ventilation arrangement, as recited in claim 15, wherein said ceiling ventilation arrangement further comprises a handle frame pivotally connected to said supporting frame, wherein said handle frame, having a U-shaped, has two ends rotatably connected to two outer sides of said base respectively in such a manner that said handle frame is capable of folding upwardly to form as a hand bar and folding downwardly to rest on said top platform.

22. The ceiling ventilation arrangement, as recited in claim 18, wherein said ceiling ventilation arrangement further comprises a handle frame pivotally connected to said supporting frame, wherein said handle frame, having a U-shaped, has two ends rotatably connected to two outer sides of said base respectively in such a manner that said handle frame is capable of folding upwardly to form as a hand bar and folding downwardly to rest on said top platform.

23. The ceiling ventilation arrangement, as recited in claim 20, wherein said ceiling ventilation arrangement further comprises a handle frame pivotally connected to said supporting frame, wherein said handle frame, having a U-shaped, has two ends rotatably connected to two outer sides of said base respectively in such a manner that said handle frame is capable of folding upwardly to form as a hand bar and folding downwardly to rest on said top platform.

24. The ceiling ventilation arrangement, as recited in claim 15, wherein said ceiling ventilation arrangement further comprises a supplementary connection link adapted for mounting on said top platform at a position in front of said supporting frame, wherein said supplementary connection link comprises at least a computer outlet adapted for communicatively connecting with a connection output of said personal computer.

25. The ceiling ventilation arrangement, as recited in claim 18, wherein said ceiling ventilation arrangement further comprises a supplementary connection link adapted for mounting on said top platform at a position in front of said supporting frame, wherein said supplementary connection link comprises at least a computer outlet adapted for communicatively connecting with a connection output of said personal computer.

26. The ceiling ventilation arrangement, as recited in claim 23, wherein said ceiling ventilation arrangement further comprises a supplementary connection link adapted for mounting on said top platform at a position in front of said supporting frame, wherein said supplementary connection link comprises at least a computer outlet adapted for communicatively connecting with a connection output of said personal computer.

27. The ceiling ventilation arrangement, as recited in claim 26, wherein said handle frame forms a boundary cavity when said handle frame is downwardly folded for resting on said top platform, wherein said supplementary connection link is mounted within said boundary cavity such that said supplementary connection link is encircled within said handle frame.
